(19) United States
(12) Patent Application Publication
(10) Pub. No.: US 2024/0152816 A1
(43) Pub. Date: May 9, 2024

(54) METHOD, APPARATUS, DEVICE AND MEDIUM FOR MANAGING CONTRASTIVE LEARNING MODEL

(71) Applicant: Beijing Youzhuju Network Technology Co., Ltd., Beijing (CN)

(72) Inventors: Hao WU, Beijing (CN); Cheng YANG, Beijing (CN)

(21) Appl. No.: 18/504,931

(22) Filed: Nov. 8, 2023

(30) Foreign Application Priority Data
Nov. 8, 2022 (CN) 202211393984.5

(51) Int. Cl. G06N 20/00

(52) U.S. Cl. CPC G06N 20/00

(57) ABSTRACT

A method, apparatus, device, and medium for managing a contrastive learning model are provided. In one method, in a first training phase, a first contrastive learning model is generated by training the contrastive learning model with a first training sample set, a negative sample pair of the first training sample set comprising only data segments from different data sequences. In a second training phase, a second contrastive learning model is generated by training the first contrastive learning model with a second training sample set, a negative sample pair in the second training sample set comprising data segments from the same data sequence. Knowledge in terms of the appearance of the samples can be fully obtained in the first training phase, and knowledge in terms of the appearance and dynamics of the samples can be fully obtained in the second training, with example implementations of the present disclosure.

### CROSS-REFERENCE TO RELATED APPLICATIONS

The present application claims priority to Chinese Patent Application No. 202211393984.5 filed on Nov. 8, 2022, and entitled “METHOD, APPARATUS, DEVICE, AND MEDIUM FOR MANAGING CONTRASTIVE LEARNING MODEL”, the entirety of which is incorporated herein by reference.

### FIELD

Example implementations of the present disclosure generally relate to machine learning, and in particular, to a method, apparatus, device, and computer-readable storage medium for managing a contrastive learning model.

### BACKGROUND

In self-supervised learning, manual labeling of samples is not required. Positive and negative samples corresponding to the samples can be constructed by modifying the samples. Further, positive and negative samples can be used to train the contrastive learning model. A training dataset comprising a large number of training samples can be obtained, the training samples in the training dataset can be divided into a plurality of batches, and the contrastive learning model can be iteratively trained with the plurality of batches of training samples in order. However, when training the contrastive learning model in different batch orders, the performance of the contrastive learning model will differ. At this time, how to determine the using order of the training samples in a training phase to improve the training performance of the contrastive learning model has become an urgent problem to be solved.

### SUMMARY

In a first aspect of the present disclosure, a method for managing a contrastive learning model is provided. In this method, in a first training phase, a first contrastive learning model is generated by training the contrastive learning model with a first training sample set, a negative sample pair of the first training sample set comprising only data segments from different data sequences. In a second training phase, a second contrastive learning model is generated by training the first contrastive learning model with a second training sample set, a negative sample pair in the second training sample set comprising data segments from the same data sequence.

In a second aspect of the present disclosure, an apparatus for managing a contrastive learning model is provided. The apparatus comprises: a first training module, configured to, in a first training phase, generate the first contrastive learning model by training the contrastive learning model with a first training sample set, a negative sample pair of the first training sample set comprising only data segments from different data sequences; and a second training module, configured to, in a second training phase, generate a second contrastive learning model by training the first contrastive learning model with a second training sample set, a negative sample pair in the second training sample set comprising data segments from the same data sequence.

In a third aspect of the present disclosure, an electronic device is provided. The electronic device comprises: at least one processing unit; and at least one memory coupled to the at least one processing unit and storing instructions to be executed by the at least one processing unit, the instructions, when executed by the at least one processing unit, causing the device to perform a method in the first aspect.

In a fourth aspect of the present disclosure, a computer readable storage medium is provided, having a computer program stored thereon, the computer program, when executed by a processor, performing a method in the first aspect.

It would be understood that the content described in the Summary section of the present disclosure is neither intended to identify key or essential features of implementations of the present disclosure, nor is it intended to limit the scope of the present disclosure. Other features of the present disclosure will be readily envisaged through the following description.

### BRIEF DESCRIPTION OF THE DRAWINGS

Through the detailed description with reference to the accompanying drawings, the above and other features, advantages, and aspects of respective implementations of the present disclosure will become more apparent. The same or similar reference numerals represent the same or similar elements throughout the figures, wherein:

FIG. 1 shows a schematic diagram of an example environment in which implementations of the present disclosure can be applied.

FIG. 2 shows a block diagram of a process of training a contrastive learning model according to a technical solution.

FIG. 3 shows a block diagram of a sample ranking during a training process according to some implementations of the present disclosure;

FIG. 4 shows a block diagram of a two-phase training process for managing the contrastive learning model according to some implementations of the present disclosure;

FIG. 5A shows a block diagram of a process for generating a negative sample pair in a first training sample set according to some implementations of the present disclosure;

FIG. 5B shows a block diagram of a process for generating a negative sample pair in a first training sample set according to some implementations of the present disclosure;

FIG. 6 shows a block diagram of a process for generating a noise data frame according to some implementations of the present disclosure.

FIG. 7 shows a block diagram of a process for generating a data frame in a third data segment according to some implementations of the present disclosure.

FIG. 8 shows a block diagram of a process for generating a negative sample pair according to some implementations of the present disclosure.

FIG. 9 shows a block diagram of a process for adjusting a sampling frequency of a data segment according to some implementations of the present disclosure;

FIG. 10 shows a block diagram of a structure of a second training sample set according to some implementations of the present disclosure;

FIG. 11 shows a block diagram of the two-phase training process for training the contrastive learning model according to some implementations of the present disclosure;

FIG. 12 shows a block diagram of a sample ranking during the training process according to some implementations of the present disclosure;

FIG. 13 shows a flowchart of a method for managing the contrastive learning model according to some implementations of the present disclosure;

FIG. 14 shows a block diagram of an apparatus for managing the contrastive learning model according to some implementations of the present disclosure; and

FIG. 15 shows an electronic device capable of implementing one or more implementations of the present disclosure.

### DETAILED DESCRIPTION

Implementations of the present disclosure will be described in more detail below with reference to the accompanying drawings. Although some implementations of the present disclosure are shown in the drawings, it would be understood that the present disclosure can be implemented in various forms and should not be interpreted as limited to the implementations described herein. On the contrary, these implementations are provided for a more thorough and complete understanding of the present disclosure. It would be understood that the drawings and implementations of the present disclosure are only for the purpose of illustration and are not intended to limit the scope of protection of the present disclosure.

In the description of implementations of the present disclosure, the term “comprising”, and similar terms should be understood as open inclusion, i.e., “comprising but not limited to”. The term “based on” should be understood as “at least partially based on”. The term “one implementation” or “the implementation” should be understood as “at least one implementation”. The term “some implementations” should be understood as “at least some implementations”. Other explicit and implicit definitions may also be comprised below.

It is understandable that the data involved in this technical proposal (comprising but not limited to the data itself, data obtaining, use, storage, or deletion) shall comply with the requirements of corresponding laws, regulations, and relevant provisions.

It is understandable that before using the technical solution disclosed in respective implementations of the present disclosure, users shall be informed of the type, using scope, and using scenario of personal information involved in the present disclosure in an appropriate way, and be authorized by users according to relevant laws and regulations.

For example, in response to receiving a proactive request from a user, prompt information is sent to the user to explicitly remind the user that a requested operation will require the obtaining and use of personal information of the user, so that the user may independently choose, according to the prompt information, whether to provide personal information to electronic devices, applications, servers or storage media and other software or hardware that perform operations of the technical solution of the present disclosure.

As an optional but non-limiting implementation, in response to receiving a proactive request from a user, the way of sending prompt information to the user may be, for example, a popup window, in which the prompt information may be presented in the form of text. In addition, the popup window may further carry a selection control for the user to choose “agree” or “disagree” to provide personal information to electronic devices.

It is understandable that the above process of notifying and obtaining user authorization is only for the purpose of illustration and does not imply any implementations of the present disclosure. Other ways, to satisfy the requirements of relevant laws and regulations, may also be applied to implementations of the present disclosure.

As used herein, the term “in response to” is to represent a state in which a corresponding event occurs or a condition is satisfied. It will be understood that the timing of the subsequent action performed in response to the event or a condition may not be strongly correlated with the time when the event occurs or the condition is satisfied. For example, in some cases, the subsequent action may be performed immediately when the event occurs or the condition is satisfied; in other cases, the subsequent action may be performed after a period after the event occurs or the condition is satisfied.

### Example Environment

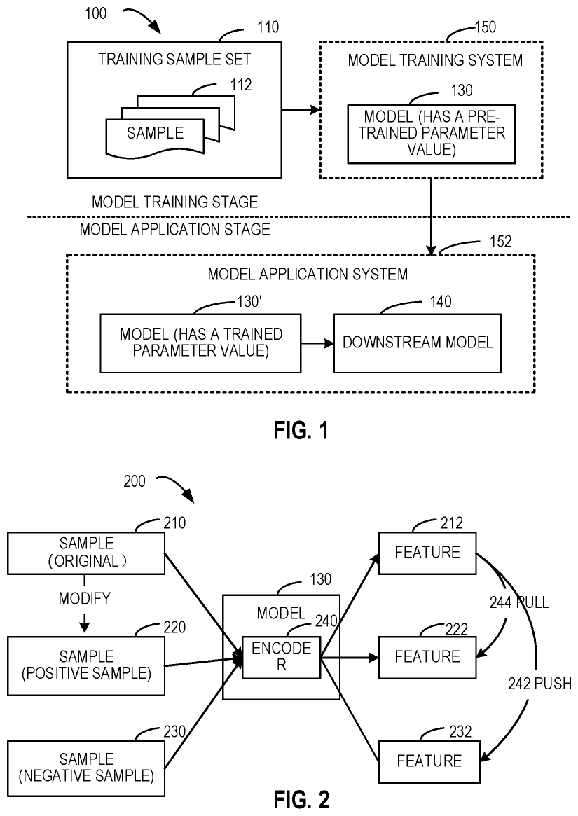

FIG. 1 shows a block diagram of an example environment 100 in which implementations of the present disclosure can be implemented. In the environment 100 of FIG. 1, it is desirable to train and use such a machine learning model (i.e., a contrastive learning model, abbreviated as model 130). The model is configured for a variety of application environments, e.g., for identifying similarities in videos, etc. As shown in FIG. 1, the environment 100 comprises a model training system 150 and a model application system 152. The upper part of FIG. 1 shows a process of a model training phase, and the lower part shows a process of a model application phase. Prior to training, a parameter value of the model 130 may have an initial value or may have a pre-trained parameter value obtained through a pre-training process. The model 130 may be trained via forward propagation and backward propagation, during which the parameter value of the model 130 may be updated and adjusted. A model 130′ may be obtained after training is complete. At this point, the parameter value of the model 130′ has been updated, and based on the updated parameter value, the model 130 may be used to implement prediction tasks during the model application phase.

During the model training phase, the model 130 may be trained with the model training system 150, based on a training sample set 110 comprising a plurality of samples 112. In contrastive learning, positive and negative samples may be constructed respectively with the plurality of samples 112, and the training process may be performed iteratively with a large number of samples. After training is completed, the model 130 may comprise knowledge associated with tasks to be processed. During the model application phase, the model 130′ (at this time, the model 130′ has a trained parameter value) may be called with the model application system 152. Further, a downstream model 140 may be called after the model 130′ to perform specific tasks.

In FIG. 1, the model training system 150 and the model application system 152 may comprise any computing system having computing power, such as various computing devices/systems, terminal devices, servers, etc. Terminal devices may involve any type of mobile terminal, fixed terminal, or portable terminal, comprising a mobile phone, a desktop computer, a laptop computer, a notebook computer, a netbook computer, a tablet computer, a media computer, a multimedia table, or any combination thereof, comprising accessories and peripherals of these devices or any combination thereof. Servers comprise but are not limited to a mainframe, an edge computing node, a computing device in a cloud environment, etc.

It should be understood that the components and arrangements in the environment 100 shown in FIG. 1 are merely examples, and a computing system suitable for implementing the example implementations described herein may comprise one or more different components, other components, and/or different arrangements. For example, although shown as separate, the model training system 150 and the model application system 152 may be integrated into the same system or device. Implementations of the present disclosure are not limited in this regard. Example implementations of the model training and the model application will continue to be described respectively below with reference to the accompanying drawings.

For the sake of description, only video processing is used as the application environment of the contrastive learning model in the present disclosure. The contrastive learning model can be used to perform video self-supervision tasks. For example, a video sequence set to be used as training samples may be obtained, and training samples can be constructed with respective video sequences in the video sequence set.

FIG. 2 shows a block diagram 200 of a process of training a contrastive learning model according to a technical solution. As shown in FIG. 2, an original sample 210 can be determined from a video, and a sample 220 (i.e., a positive sample) can be generated by modifying the original sample 210. Further, a sample 230 (e.g., a sample from other videos, or a dynamically adjusted sample from the same video) can be determined as a negative sample. The samples 210 and 220 can be determined as positive sample pairs, and the samples 210 and 230 can be determined as negative sample pairs to train the model 130. During the training process, an encoder 240 in the model 130 can respectively output features of samples 210, 220, and 230, i.e., features 212, 222, and 232. As shown by arrow 244, the model 130 can be trained in the direction of pulling closer the distance between features 212 and 222; as shown by arrow 242, the model 130 can be trained in the direction of pushing farther the distance between features 212 and 232. The training process can be iteratively performed with a large number of positive and negative sample pairs.

Various technical solutions have been provided for constructing positive and negative samples. For example, a sample from the same video can be determined as a positive sample. In a BE technical solution, videos other than the positive samples can be directly determined as negative samples. This leads to the contrastive learning model being unable to perceive dynamic information of video content (e.g. a playing speed), and a large number of training videos need to be prepared to obtain sufficient negative samples. In a Pace technical solution, the sampling frequency of videos other than positive samples can be adjusted (i.e., variable speed, for example, the sampling frequency can be adjusted from 0.25 seconds per frame to 0.5 seconds per frame, or other values), and the adjusted video can be determined as a negative sample. In an RSPNet technical solution, the sampling frequency of videos of positive samples can be adjusted, and the adjusted video can be determined as a negative sample. The adjusted video has a different playing speed from the pre-adjusted video, which causes the contrastive learning model to distinguish between positive and negative samples in terms of the dynamic information.

At this time, a negative sample can come from the same video where the original sample 210 locates (referred to as an intra-video negative sample) or can come from different videos where the original sample 210 locates (abbreviated as an inter-video negative sample). Positive and negative sample pairs can be created with positive and negative samples generated through the above methods, and then the training process can be performed. The training sample set can be divided into a plurality of batches, and the contrastive learning model can be iteratively trained with the training samples of respective batches. During the training process, a ranking of samples within the batches will change: the ranking of positive samples will gradually decrease as the training process is performed, and the ranking of negative samples will gradually increase.

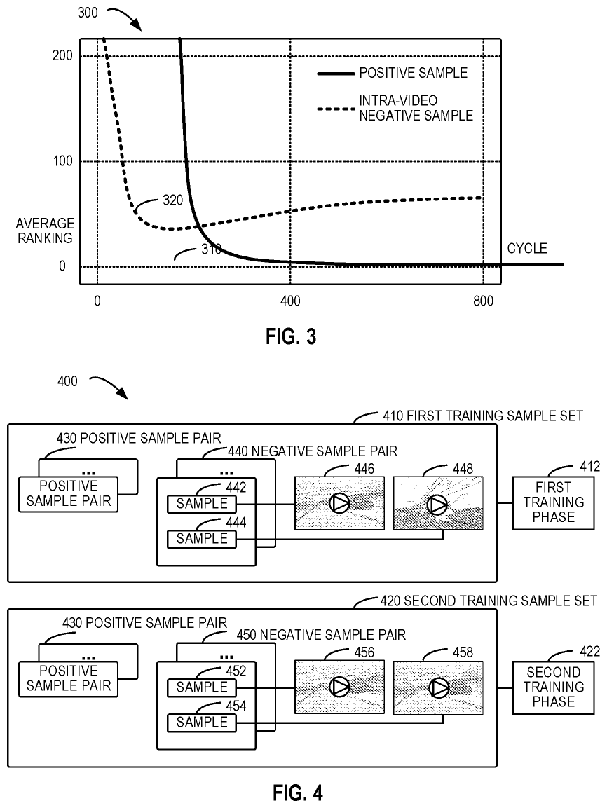

It will be understood that due to an existence of negative samples constructed in a plurality of ways, using different negative samples in different periods (epochs) of the training process may affect the training effect of the contrastive learning model and thus affect the accuracy of the contrastive learning model. Refer to FIG. 3 for a description of an impact of the training process on the ranking of samples. FIG. 3 shows a block diagram 300 of a sample ranking during a training process according to some implementations of the present disclosure. As shown in FIG. 3, a horizontal coordinate represents the epoch of training and a vertical coordinate represents an average ranking of the samples. Curve 310 shows the average ranking of positive samples, and curve 320 shows the average ranking of the intra-video negative samples.

From the curve 310, it can be seen that the ranking of positive samples drops sharply in the early phase of training, and then continues to drop to close to 0 (i.e., ranking first). From the curve 320, it can be seen that the ranking of the intra-video negative samples drops sharply at the beginning of training, indicating that the contrastive learning model focuses more on learning an appearance (i.e., learning to distinguish whether two samples come from the same video) during the period. In the later phase of training, the model begins to learn the dynamic part of negative samples (i.e., semantic knowledge about speed adjustment), and at this time the curve 320 gradually rises.

From FIG. 3, it can be seen that when the model needs to learn both the appearance and dynamics at the same time, the model will prioritize learning the appearance (the difference of appearances is obvious and easy to learn), and then gradually learn the dynamic aspects. Therefore, in the early phase of training, the intra-video negative samples play a negative role in training. Specifically, in the early phase of training, on the one hand, the model needs to learn appearance in order to push farther samples that do not belong to the same video as negative samples with different appearances and to pull closer samples that belong to the same video. On the other hand, the intra-video negative samples belong to the same video as the original samples, but as negative samples, which conflicts with the learning goal of the model to learn the appearance. In other words, the two effects of the intra-video negative samples will conflict with each other, thereby affecting the effectiveness of the model training. At this time, it is expected that the training samples can be selected and the training process can be performed in a way that is more efficient for the training of the contrastive learning model.

### Summary Description of the Model Training Process

In order to at least partially address the shortcomings described above, a method for managing contrastive learning models is provided. A summary of an example implementation according to the present disclosure is described with reference to FIG. 4, which shows a block diagram 400 of a two-phase training process for managing the contrastive learning model according to some implementations of the present disclosure. As shown in FIG. 4, the training process can be divided into two phases: a first training phase 412 and a second training phase 422. In both training phases, training can be performed with a first training sample set 410 and a second training sample set 420, respectively.

As shown in FIG. 4, the first training sample set 410 may comprise a plurality of positive sample pairs 430 and a plurality of negative sample pairs 440, where two samples 442 and 444 in the negative sample pairs 440 come from different data sequences. In other words, the negative sample pairs 440 in the first training sample set 410 only comprise data segments from different data sequences (e.g., a first data segment 446 and a second data segment 448). In the initial phase of training, the contrastive learning model 130 can be trained with the first training sample set 410 to generate the first contrastive learning model. The first training phase 412 can be called a warm-up phase, and the warm-up phase can perform training based on negative sample pairs from different videos in order to learn knowledge in terms of the appearance in the video.

Further, the second training sample set 420 may comprise a plurality of positive sample pairs 430 and a plurality of negative sample pairs 450, where two samples 452 and 454 of the negative sample pairs 450 may come from data segments of the same data sequence, but do not exclude the two samples 452 and 454 of the negative sample pairs 450 from data segments of different data sequences (e.g., data segments 456 and 458). After the first training phase 412, the second training phase 422 may be performed, where training may be performed based on samples from the same and/or different videos in order to learn knowledge in terms of the dynamics and/or appearance in the videos.

With example implementations of the present disclosure, the use of negative sample pairs based on different ways of generating negative sample pairs in the two training phases allows for the selection of a suitable negative sample pair based on the respective training objectives of the two training phases, thereby improving the performance of the training process, increasing the convergence speed and accuracy of the machine learning mode.

### Detailed Description of the Model Training Process

A summary of the two-phase training process has been described, and more details of a process of determining positive and negative sample pairs in the first training sample set 410 and the second training sample set 420 will be described below with reference to the accompanying drawings. First, a process of generating a negative sample pair 440 in the first training sample set 410 is described. According to an example implementation of the present disclosure, two data segments can be obtained from two data sequences used to train the contrastive learning model, and then the negative sample pair 440 in the first training sample set 410 can be generated with the two obtained data segments.

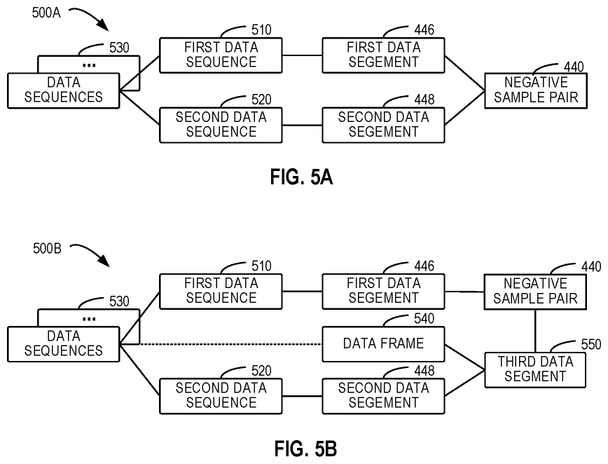

FIG. 5A shows a block diagram 500A of a process for generating a negative sample pair in a first training sample set according to some implementations of the present disclosure. As shown in FIG. 5A, a plurality of data sequences 530 may comprise a first data sequence 510 and a second data sequence 520, a first data segment 446 may be obtained from the first data sequence 510, and a second data segment 448 may be obtained from the second data sequence 520. In an application environment of video processing, the data sequences in FIG. 5A may be video sequences, alternatively and/or additionally, the data sequences may comprise sequences in other formats. For example, in the context of audio processing applications, the data sequences may comprise audio sequences. In other application scenarios, the data sequence may also comprise sequences such as thermal image sequences, temperature sequences, humidity sequences, or other monitored parameters.

Here, the two data sequences may respectively comprise a plurality of data frames, and their resolutions and lengths may be the same or different. Further, the first data segment 446 may be obtained from the first data sequence 510. At this time, the first data segment 446 may comprise a portion of the data frames in a plurality of data frames in the first data sequence 510. The first data segment 446 may have a predetermined length, assuming that the first data sequence comprises N (positive integer) data frames, and the first data segment 446 may comprise n (positive integer) data frames (n<N). Subsequently, the second data segment 448 may be selected from the second data sequence 520 in a similar way. The first data segment 446 and the second data segment 448 may have the same length (e.g., comprising n data frames). Further, the first data segment 446 and the second data segment 448 may be combined to generate the negative sample pair 440.

At this time, the first data segment 446 and the second data segment 448 are from different videos, so the second data segment 448 can be referred to as inter-video samples relative to the first data segment 446. With the example implementation of the present disclosure, negative sample pairs involving different videos in the first training sample set 410 can be constructed in a simple and effective manner. In this way, during the first training phase 412, the contrastive learning model can be enabled to be more focused on the knowledge in terms of the appearance of learning samples, thereby improving the performance of the training process.

It will be understood that FIG. 5A only schematically shows a simple example for generating the negative sample 440 to which, alternatively and/or additionally, noise may be added to the sample in order to improve the robustness of the machine learning model. It will be understood that noise here may comprise both factors of appearance and sampling frequency (e.g., a playing speed of a video). For example, for appearance, data from other data frames may be introduced into respective video frames in the second data segment 448. In another example, as for sampling frequency, frame extraction or frame interpolation operations may be conducted to a plurality of data frames in the second data segment 448 to generate data segments with different sampling frequencies.

FIG. 5B shows a block diagram 500B of a process for generating a negative sample pair in the first training sample set according to some implementations of the present disclosure. As shown in FIG. 5B, a data frame 540 may be selected from data sequences other than the second data sequence 520 of the plurality of data sequences 530. Here, the data frame 540 will be determined as an interferer, and noise may be added to the generated negative samples, thereby increasing the training difficulty and improving the accuracy of the contrastive learning model.

The data frame 540 can be selected based on various methods. For example, the data frame 540 can be randomly selected, a data frame at a specific location can be selected, or the data frame 540 can be selected based on contents of a data sequence. The third data segment 550 (i.e., negative sample) can be generated based on the second data segment 448 and the data frame 540. In other words, respective data frames in the second data segment 448 can be modified with the data frame 540, thereby generating the third data segment 550. Further, the negative sample pair 440 for training the contrastive learning model can be determined with the first data segment 446 and the third data segment 550.

In the application environment of video processing, two different video segments can be determined from different video sequences, and the two video segments can be used as the basis for constructing a negative sample pair. One of the two video segments can be used as an original video segment, and the other can be used as a negative sample. Further, the appearance of a negative sample can be disturbed with video frames from different video sequences (for example, fusing the content of video frames into respective video frame in the negative sample, i.e., overlapping two video frames). Subsequently, the original video segment and the perturbed negative sample can be determined as a negative sample pair.

It will be understood that at this time, the negative sample is modified based on video frames from other video sequences, so more radical appearance perturbations can be introduced into the negative sample, thereby destroying an original information in the negative sample. The video frames from other video sequences usually have different color information, compared with a technical solution based solely on adjusting the sampling frequency of a video, a stronger perturbation can be introduced into a negative sample in terms of appearance, thereby providing a negative sample with richer semantic information. Different video frames can be determined as interference factors and a large number of negative samples can be generated. In this way, more negative samples with richer appearance information can be generated without a requirement to expand the training sample set, thereby improving an accuracy of the contrastive learning model.

According to an example implementation of the present disclosure, a noise data frame can be generated based on the data frame 540, and then a data frame in the second data segment 448 can be updated with the noise data frame. For example, the data frame 540 can be directly fused to each data frame in the second data segment 448 (i.e., the data frame 540 is superimposed on each data frame) to generate the third data segment 550 as a negative sample. In this way, the data frame 540 will be directly fused to each video frame in the second data segment 448, and the negative sample can comprise richer semantic information, thereby improving the generalization ability of the contrastive learning model. Further, the fusion process only involves simple processing and does not significantly increase the workload of generating negative samples. In this way, the negative sample can be generated in a simple and efficient way.

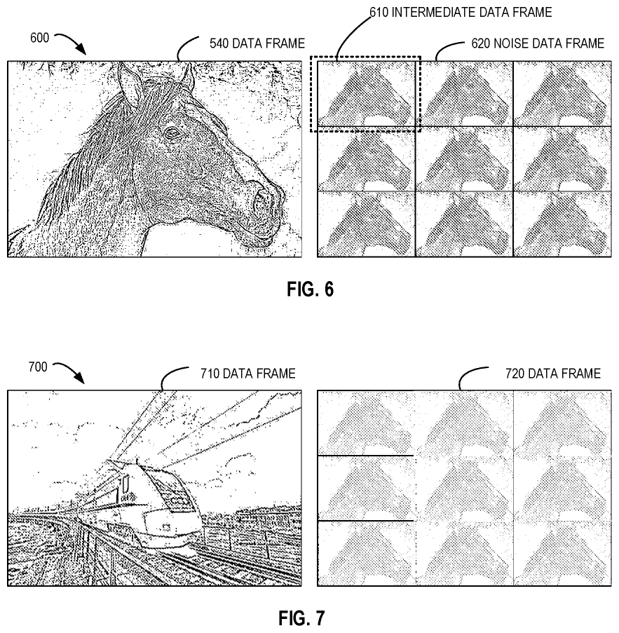

According to an example implementation of the present disclosure, in order to further enrich the appearance information of the negative sample, high-frequency information can be added to the third data segment 550. Specifically, a high-frequency noise data frame can be generated based on the data frame 540, and respective data frames in the second data segment 448 can be updated with the noise data frame. The process of generating the noise data frame is described in FIG. 6, which shows a block diagram 600 of a process for generating the noise data frame according to some implementations of the present disclosure.

As shown in FIG. 6, the data frame 540 represents a data frame used as interference data. Dimensions of the data frame 540 can be adjusted according to a predetermined ratio (for example, reducing a height and width of a video frame to 1/K of the original, for example K=3 or other values) to generate an intermediate data frame 610. The intermediate data frame 610 can be copied, and a plurality of copied intermediate data frames can be generated, and then the plurality of copied intermediate data frames can be joined to generate a noise data 620. At this time, the noise data frame 620 will comprise K*K reduced data frames.

It will be understood that although the adjustment of the same ratio is performed in both the height and width dimensions as shown above, alternatively and/or additionally, different adjustment methods can be performed. For example, only the ratio of the height dimension can be adjusted to generate noise data compressed by height. As another example, only the ratio of the width dimension can be adjusted to generate noise data compressed by width. As another example, the height dimension and the width dimension can be adjusted in different proportions to generate noise data frames with different scaling ratios in the height and width directions (for example, the ratio in the height direction is K1, and the ratio in the width direction is K2). It will be understood that although the above shows the case in which the noise data frame comprises intermediate images that are exactly an integer multiple, alternatively and/or additionally, the noise data can comprise intermediate images that are not integer multiples. For example, the noise data frame can comprise 6 complete intermediate data frames and 3 incomplete intermediate data frames.

In the following, how to generate the noise data frame 620 will be described with a specific formula. Assuming that a symbol X represents the data frame 540, adjustments can be conducted to the height and width dimensions of the data frame 540, so that the height H and width W of the data frame 540 are respectively adjusted to 1/K1 and 1/K2 of the original. At this time, the dimension of the intermediate data frame 610 is H/K1*W/K2. The K1*K2 copied intermediate data frames 610 can be joined to generate the noise data frame 620 of dimension H*W (represented by a symbol D).

Further, the noise data frame 620 may be fused to respective data frames in the second data segment 448, thereby generating the third data segment 550. According to an example implementation of the present disclosure, respective data frames in the second data segment 448 may be updated with the noise data frame 620. FIG. 7 shows a block diagram 700 of a process for generating the data frame 720 in the third data segment 550 in accordance with some implementations of the present disclosure. As shown in FIG. 7, only a data frame 710 is described as an example of the data frame in the second data segment 448. The data frame 710 may be fused with the noise data frame 620 to generate a data frame 720 in the third data segment 550.

According to an example implementation of the present disclosure, each pixel in the data frame 720 can be determined one by one. For example, assuming that the second data segment 448 is represented by a symbol V′ᵢ and the j^{th} frame in the second data segment 448 is represented by a symbol V′ᵢ(j), the data frame 720 in the third data segment 550 can be determined based on Formula 1.

V̅′ᵢ(j)=(1−λ)V′ᵢ(j)+λD Formula 1

In Formula 1, the third data segment 550 is represented by V̅ᵢ, pixel data of the j^{th} frame in the third data segment 550 is represented by V̅′ᵢ(j), a predetermined weight of the noise data frame 620 is represented by λ, and pixel data of the noise data frame 620 is represented by D. Each data frame in the second data segment 448 can be processed based on Formula 1 to generate a data frame in the third data segment 550.

Specifically, a data value (e.g., a pixel value) of a given data point is obtained for which (e.g., a pixel at a position (x, y)) in the data frame 710 in the second data segment 448. Subsequently, a corresponding data value of a data point corresponding to the given data point in the noise data frame 620 can be obtained. Further, a data value of a data point corresponding to the given data point in the data frame 720 can be determined based on the data value, the corresponding data value, and the weight of the noise data frame. In other words, the pixel value of the pixel at the position (x, y) in the synthesized data frame 720 can be determined based on the pixel value of the pixel at the position (x, y) in the data frame 710, the pixel value of the pixel at the position (x, y) in the noise data frame 620, and the weight.

It will be understood that the pixel values can comprise three channels of RGB (red, green, and blue), so the pixel values in each channel can be processed separately, and then the pixel values in each channel in the data frame 720 can be determined. Assuming that the three channels of RGB in the j^{th} frame are respectively represented by V′ᵢ^{R}(j), V′ᵢ^{G}(j), and V′ᵢ^{B}(j), the pixel values of respective channels of the j^{th} frame of the third data segment 550 can be determined based on Formula 2:

V′ᵢ^{R}(j)=(1−λ)V′ᵢ^{R}(j)+λD^{R}

V̅′ᵢ^{G}(j)=(1−λ)V′ᵢ^{G}(j)+ΔD^{G}

V̅′ᵢ^{B}(j)=(1−λ)V′ᵢ^{B}(j)+λD^{B} Formula 2

In Formula 2, pixel data of the three channels of the j^{th} frame in the third data segment 550 is represented respectively by V′ᵢ^{R}(j), V′ᵢ^{G}(j), and V′ᵢ^{B}(j), the predetermined weight of the noise data frame 620 is represented by λ, pixel data of the three channels of the noise data frame 620 is represented respectively by D^{R}, D^{G}, and D^{B}. Each data frame in the second data segment 448 can be processed based on Formula 2 to generate a data frame in the third data segment 550.

According to an example implementation of the present disclosure, a weight λ can be modified to adjust a degree of interference of the noise data frame 620 to respective data frames in the second data segment 448. Specifically, reducing the value of the weight λ can add less noise, and increasing the value of the weight λ can add more noise. A too-small weight λ can only introduce a tiny noise, which may cause the generalization ability of the contrastive learning model insufficient. A too-large weight λ will introduce a large amount of noise, which may cause the contrastive learning model to ignore dynamic information carried by an original data segment (i.e., an action change relationship between respective data frames), and then introduce uncertain factors into the contrastive learning model. A balance can be conducted between the above two aspects, and a suitable weight can be selected.

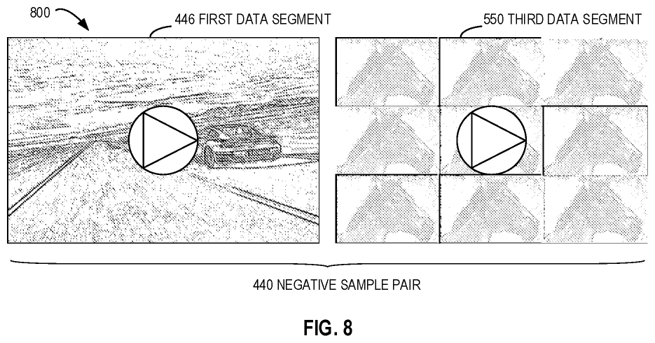

FIG. 8 shows a block diagram 800 of a process for generating a negative sample pair according to some implementations of the present disclosure. In the case where the third data segment 550 has been generated, the first data segment 446 and the third data segment 550 may be combined to generate the negative sample pair 440 in the first training sample set 410. In the first training phase 412, the contrastive learning model may be trained with the negative sample pair 440 to push away a distance between features of the first data segment 446 and the third data segment 550.

It will be understood that, although only the process of generating one negative sample pair is described in the foregoing, a plurality of negative sample pairs may be generated in a similar way. Assuming that a data sequence collection comprises m data sequences, any one of the m data sequences may be determined as the first data sequence 510 described above, and any one of the remaining m−1 data sequences may be determined as the second data sequence 520 described above. The first data segment 446 may be determined from the first data sequence 510, and the second data segment 448 may be determined from the second data sequence 520, and the data frame 540 may be determined from other data sequences. Further, the third data segment 550 can be generated by updating the second data segment 448 with the data frame 540. Subsequently, the negative sample pair 440 can be generated by combining the first data 446 and the third data segment 550. In this way, a large number of the negative sample pairs 440 may be generated to iteratively update the contrastive learning model, thereby allowing the model to gain more knowledge regarding the appearance of the samples.

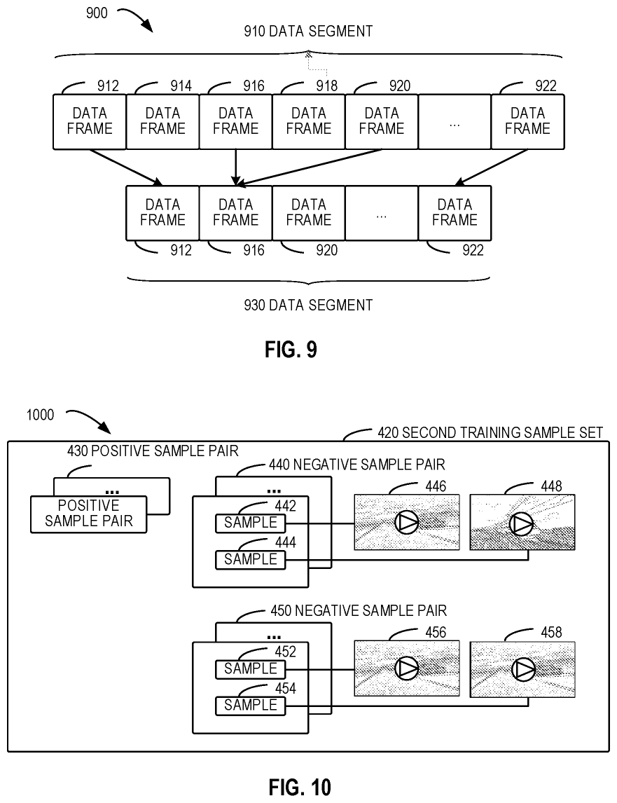

The process of adding perturbation information to negative samples from different data sequences in order to generate the negative sample pair 440 in the first training sample set 410 has been described above. Alternatively and/or additionally, a sampling frequency of the data segment used as a negative sample can be adjusted so as to allow the contrastive learning model to more strongly perceive the dynamic information in the sample. FIG. 9 shows a block diagram 900 of a process for adjusting a sampling frequency of a data segment according to some implementations of the present disclosure. As shown in FIG. 9, assuming that a data segment 910 is a negative sample (e.g., the second data segment 448 in FIG. 5A, or the third data segment 550 in FIG. 5B), and comprises a plurality of data frames 912, 914, 916, 918, 920, . . . , 922. At this time, a portion of the data frames, i.e., data frames 912, 916, 920, . . . , 922, can be selected from the plurality of data frames at a predetermined interval by, for example, “down-sampling”, and a data segment 930 after adjusting the sampling frequency can be generated.

Compared with the data segment 910, dynamic changes of respective data frames in the data segment 930 will be more significant, which can cause the contrastive learning model to perceive the dynamic information in addition to the appearance information of the data frame, thereby enhancing the performance of the contrastive learning model. Specifically, in a video processing scenario, the data segment 930 can be a video with a faster playing speed, which causes the contrastive learning mode to better grasp the dynamic changes between respective video frames.

According to an example implementation of the present disclosure, the process of adjusting the sampling frequency described above can be performed directly on data segments (e.g., the second data segment 448 in FIG. 5A) from different data sequences. Alternatively and/or additionally, the process of adjusting the sampling frequency described above can be performed on interfered data segments (e.g., the third data segment 550 in FIG. 5B) from different data sequences. In this way, the negative sample pairs in the first training sample set 410 can comprise richer training data, thereby improving the training effect of the contrastive learning model.

The process of constructing the negative sample pair 440 in the first training sample set 410 with data segments from different data sequences has been described above. According to an example implementation of the present disclosure, the second training sample set 420 can be constructed based on the first training sample set 410. Hereinafter, a process of constructing a negative sample pair in the second training sample set 420 will be described with reference to FIG. 10. FIG. 10 shows a block diagram 1000 of a structure of a second training sample set according to some implementations of the present disclosure. As shown in FIG. 10, the positive sample pair 440 and the negative sample pair 440 in the first training sample set 410 can be added to the second training sample set 420. Further, the negative sample pair 450 can be generated based on two data segments from the same data sequence.

At this time, the samples 452 and 454 in the negative sample pair 450 are the data segments 456 and 458 from the same data sequence (e.g., the first data sequence 510 described above). Specifically, a fourth data segment can be obtained from the first data sequence 510. The sampling frequency of a plurality of data frames in the fourth data segment can be adjusted according to the method shown in FIG. 9 to generate a fifth data segment. Further, the first data segment 446 and the fifth data segment can be combined to generate the negative sample pair 450 in the second training sample set 520.

It will be appreciated that although the process of generating the negative sample pair 450 in the second training sample set 420 based on the same data sequence has been described above, a plurality of the negative sample pairs 450 may be generated in a similar way. For example, the fourth data segment may be adjusted to different speeds to generate a plurality of the fifth data segments. The first data segment 446 may be combined with a plurality of the fifth data segments having different speeds, respectively, to generate corresponding negative sample pairs. As another example, a plurality of data segments may be selected respectively at different locations from the first data sequence 510, and the first data segment 446 may be combined with the respective shifted speeds to generate corresponding negative sample pairs.

The first data segment 446 and the fifth data segment have a similar appearance and different speeds, and the first data segment 446 and the fifth data segment can be combined to determine the negative sample pair used to train the contrastive learning model. In this way, more dynamic changes can be introduced into the negative sample pair, and the number of negative sample pairs can be further increased.

The process of determining negative sample pairs in the first training sample set 410 and the second training sample set 420 has been described above. Hereinafter, how to determine positive samples in the two training sample sets will be described. According to an example implementation of the present disclosure, a positive sample pair can be generated based on two data segments from the same data sequence and having the same speed. At this time, a sixth data segment can be obtained from the first data sequence 510, and the first data segment 446 can be directly combined with the sixth data segment to determine the positive sample pair.

Alternatively and/or additionally, noise information can be added to the a positive sample pair to improve the accuracy of the contrastive learning model by increasing the difficulty of the positive sample pair. Similar to the process of adding noise to a negative sample described above, data frames can be selected from other data sequences other than the first data sequence 510 in plurality of data sequences 530. The data frame (or noise data frame generated based on a copy operation) can be fused into respective data frames in the first data sequence 510 to generate a seventh data segment used as a positive sample. Subsequently, the first data segment 446 and the seventh data segment can be combined to determine the positive sample pair in the first training sample set 410 and the second training sample set 420. With the example implementation of the present disclosure, positive sample pairs in respective training data set can be generated in a more diverse way to improve the training effect of the contrastive learning model.

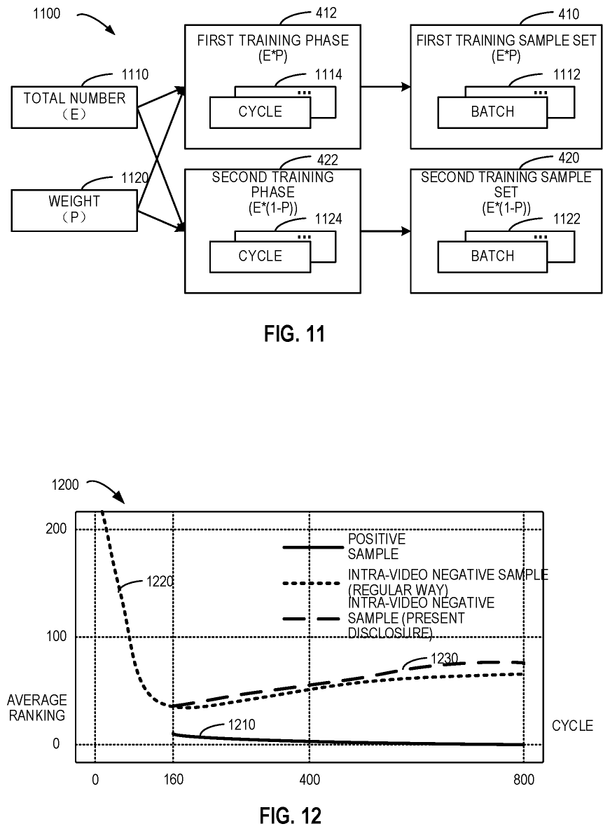

According to an example implementation of the present disclosure, the training process may be performed in a plurality of training cycles based on an iterative approach during respective training phases. Further details about the training process are described with reference to FIG. 11, which shows a block diagram 1100 of the two-phase training process for training the contrastive learning model according to some implementations of the present disclosure. As shown in FIG. 11, a total number of the training cycles (E, e.g., 800 or other values) used to train the contrastive learning model and a weight 1120 (P, e.g., 20% or other values) associated with the first training phase 412 can be obtained. Subsequently, the number of the plurality of training cycles for the first training can be determined based on the total number E and weight P.

Specifically, the number of a plurality of cycles 1114 in the first training phase 412 can be determined based on E*P (800*20%=160); further, the number of a plurality of cycles 1124 in the second training phase 422 can be determined based on E*(1−P)(800*(1−20%)=640). At this time, the first training sample set 410 can comprise samples from a plurality of batches 1112, and the number of the plurality of batches 1112 is equal to the number of the plurality of cycles 1114. Similarly, the second training sample set 420 can comprise samples from a plurality of batches 1122, and the number of the plurality of batches 1122 corresponds to the number of the plurality of cycles 1124. In other words, a batch of training samples can be generated and called in respective training cycle to iteratively train the contrastive learning model.

Subsequently, in respective training cycles in the first training phase 412, a corresponding batch of training data can be called. At this time, after the plurality of cycles 1114, the first contrastive learning model can be generated. After the first training phase 412, the first contrastive learning model can fully learn the knowledge in terms of the appearance carried by positive and negative sample pairs in the first training sample set 410.

Then, in respective training cycles in the second training phase 422, a corresponding batch of training data can be called. At this time, after the plurality of cycles 1124, the second contrastive learning model can be generated. After the second training phase 422, the second contrastive learning model can fully learn the knowledge in terms of the appearance and/or dynamic carried by positive and negative sample pairs in the second training sample set 420. In this way, the two-phase training process can improve the training efficiency and the accuracy of the contrastive learning model.

With the process described above, negative sample pairs and positive sample pairs can be generated in various ways. In summary, positive sample pairs can be generated with data segments from the same data sequence. Further, negative sample pairs can be generated with data segments from different data sequences or speed-adjusted data segments from the same data sequence. For example, for any data segment in two data segments from different data sequences, interference information can be added to the data segment based on the formula described above to adjust the appearance information of the sample. Alternatively and/or additionally, a sampling frequency of the data segment can be modified to adjust the dynamic information of the sample. Alternatively and/or additionally, both of the above operations can be performed to adjust both the appearance information and dynamic information of the sample.

Table 1 below shows a plurality of data segments from the same data sequence in symbols, and Table 2 below shows a plurality of data segments from different data sequences in symbols.

TABLE 1
Data segments from data segment i

| Number | Symbol | Description |
|---|---|---|
| 1 | Vᵢ | A data segment in the data sequence i |
| 2 | Vᵢ′ | Another data segment in the data sequence i |
| 3 | Vᵢ⁺ | A fused positive sample, i.e., a positive sample obtained |
| | | after adding perturbation information to the data |
| | | segment Vᵢ |
| 4 | Vᵢ₍ₘₒₜᵢₒₙ₎⁻ | A negative sample obtained after adjusting a sampling |
| | | frequency of the data segment Vᵢ′, i.e., a speed-adjusted |
| | | negative sample |
| 5 | V_{i(masked+motion)}⁻ | A negative sample obtained after adjusting a sampling |
| | | frequency of the data segment Vᵢ⁺, i.e., a fused and |
| | | speed-adjusted negative sample |

TABLE 2
Data segments from data segment j

| Number | Symbol | Description |
|---|---|---|
| 1 | V_{j≠i} | A data segment from the data sequence j |
| 2 | V_{j≠i}⁺ | A fused data segment from the data sequence j |
| 3 | V_{j≠i(motion)}⁻ | A speed-adjusted data segment from the data |
| | | sequence j |
| 4 | V_{j≠i(masked+motion)}⁻ | A fused and speed-adjusted data segment from |
| | | the data sequence j |

According to an example implementation of the present disclosure, the positive sample can comprise Vᵢ⁺. The negative sample can comprise data segments Vᵢₙₜᵣₐ (Vᵢ₍ₙₒₜᵢₒₙ₎⁻ and V_{i(masked+motion)}⁻) from the same data sequence. In other words, the data segments from the same data sequence can be used as negative samples after a speed-adjusted operation. Alternatively and/or additionally, the negative sample can also comprise data segments Vᵢₙₜₑᵣ from different data sequences (comprising V_{j≠i}, V_{j≠i}⁺, V_{j≠i(motion)}⁻, and V_{j≠i(masked+motion)}⁻) In other words, data segments from different data sequences can be used as negative samples, and in order to improve information richness of negative samples, image fusion, speed adjusting, or image fusion and speed adjusting can be performed for data segments from different data sequences.

According to an example implementation of the present disclosure, positive and negative sample pairs can be respectively constructed with the respective data segments shown above. For example, positive sample pairs in the first training sample set 410 and the second training sample set 420 can comprise: (Vᵢ, Vᵢ⁺). Negative sample pairs in the first training sample set 410 can comprise ((Vᵢ, (V_{j≠i}), (Vᵢ,V_{j≠i}⁺), (Vᵢ,V_{j≠i(motion)}⁻), (Vᵢ,V_{j≠i(masked+motion)}⁻) Negative sample pairs in the second training sample set 420 can comprise (Vᵢ,Vᵢ₍ₘₒₜᵢₒₙ₎⁻), (Vᵢ, V_{i(masked+motion)}⁻) (Vᵢ, V_{j≠i}), (Vᵢ, V_{j≠i(motion)}⁻),(Vᵢ, V_{j≠i(masked+motion)}⁻). With the example implementation of the present disclosure, positive and negative sample pairs comprising rich semantic information can be constructed.

Further, the contrastive learning model can be trained with the positive and negative sample pairs described above. In this way, positive sample pairs can narrow features between positive samples, and negative sample pairs can push away features between negative samples. In this way, the accuracy of the contrastive learning model can be improved.

Referring to FIG. 12, which describes the performance of the contrastive learning model generated with a two-phase training method, FIG. 12 shows a block diagram 1200 of a sample ranking during the training process according to some implementations of the present disclosure. As shown in FIG. 12, curve 1210 shows the average ranking of positive samples, curve 1220 shows the average ranking of the contrastive learning model obtained with a conventional approach for the intra-video negative samples, and curve 1230 shows the average ranking of the contrastive learning model obtained with the present disclosure for the intra-video negative samples. As can be seen from FIG. 12, with the two-phase training approach of the present disclosure, the ranking of the intra-video negative samples is significantly better than that of the intra-video negative samples with the conventional approach. This represents that learning of pure appearance can be performed in the first training sample set 410 without introducing interference of the intra-video negative samples for appearance. In this way, the learning of dynamic information in the second training sample set 420 can be facilitated.

It will be understood that although the training process has only been described with the video sequences as examples of the data sequences, alternatively and/or additionally, the data sequences may also comprise sequences for example an audio sequence, thermal image sequence, temperature sequence, humidity sequence, or other monitored parameters. Specifically, in the case of processing the audio data, the audio data can be sampled at a predetermined frequency and an audio data sequence at a predetermined sampling point can be generated. The audio data sequence can be processed in the way described above to generate corresponding positive and negative sample pairs, and then perform a two-phase training process.

The first training phase 412 helps the contrastive learning model fully learn the knowledge of the appearance carried by respective samples, and the second training phase 422 helps the contrastive learning model fully learn the knowledge of the appearance and/or dynamic carried by respective samples. In this way, the two-phase training process can improve the training efficiency and accuracy of the contrastive learning model.

### Model Application Process

According to an example implementation of the present disclosure, after the two-phase training process has been performed with the method described above, an association between two data segments in the sample pair to be processed can be determined with the generated second comparison learning model. Here, the sample pair to be processed can comprise the first data segment and the second data segment. In the case of video processing, the first data segment and the second data segment can be two video segments, and the contrastive learning model can determine whether the two video segments are consistent. Since the second contrastive learning model already has knowledge of both the appearance and the dynamics of videos, the consistency between the two data segments can be determined in a more accurate and reliable way.

According to an example implementation of the present disclosure, the effect of training the contrastive learning model with the provided technical solution can be verified under a plurality of public datasets. Table 3 below shows evaluation results in downstream scenarios using a full fine-tuning and linear evaluation. Here, the full fine-tuning and linear evaluation are two forms used for downstream task training, wherein the full fine-tuning means that trained model parameters directly participate in a full-parameter fine-tuning training in downstream tasks, and the linear evaluation represents that only a last fully connected layer is adjusted, and other parameters are fixed.

TABLE 3
Accuracy of the contrastive learning model obtained
with the two-phase training process

| | | |
|---|---|---|
| WEIGHTS P OF | FULL | LINEAR |
| THE FIRST | FINE-TUNING | EVALUATION |

| TRAINING PHASE | UCF | HMDB | UCF | HMDB |
|---|---|---|---|---|
| 0% | 81.7 | 52.3 | 74.9 | 41.4 |
| 10% | 82.8 | 53.0 | 75.6 | 42.0 |
| 20% | 82.7 | 53.0 | 76.6 | 42.9 |
| 40% | 81.0 | 50.8 | 74.2 | 40.8 |
| 60% | 80.0 | 49.7 | 72.1 | 39.9 |

In Table 3, the first column represents a weight of the first training phase, while UCF and HMDB represent different datasets. From Table 3, it can be seen that the two phases can improve the accuracy of the contrastive learning model. On different datasets, a corresponding optimal accuracy can be obtained by selecting different weights P. For example, on the UCF dataset, a highest accuracy can be obtained when P=10%.

### Example Process

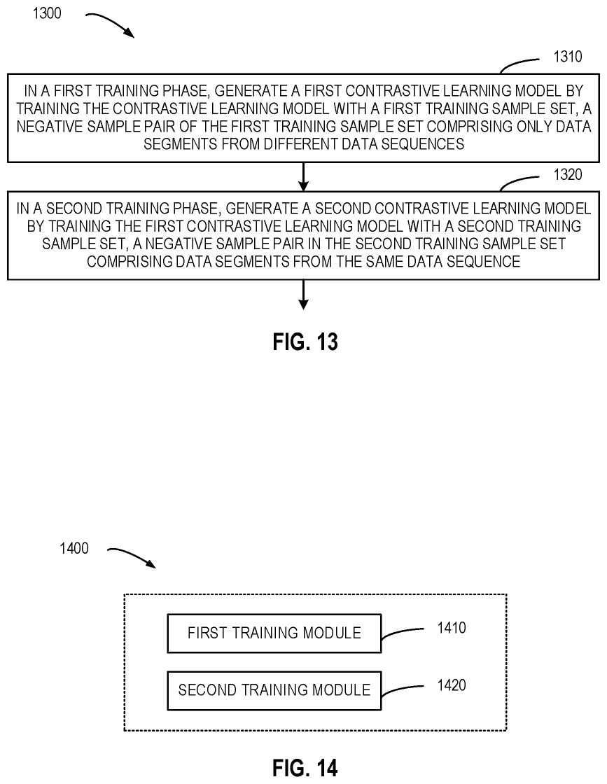

The specific process of generating samples has been described above. Hereinafter, a corresponding method is described with reference to FIG. 13. FIG. 13 shows a flowchart of a method 1300 for managing the contrastive learning model according to some implementations of the present disclosure. At block 1310, in a first training phase, a first contrastive learning model is generated by training the contrastive learning model with a first training sample set, a negative sample pair of the first training sample set comprising only data segments from different data sequences. At block 1320, in a second training phase, a second contrastive learning model is generated by training the first contrastive learning model with a second training sample set, a negative sample pair in the second training sample set comprising data segments from the same data sequence.

According to an example implementation of the present disclosure, the method 1300 further comprises: generating a negative sample pair of the first training sample set by: obtaining a first data segment from a first data sequence of a plurality of data sequences for training the contrastive learning model, and obtaining a second data segment from a second data sequence of the plurality of data sequences; and generating the negative sample pair based on the first data segment and the second data segment.

According to an example implementation of the present disclosure, generating the negative sample pair based on the first data segment and the second data segment further comprises:

generating a third data segment by updating at least one of an appearance and a sampling frequency of a plurality of data frames of the second data segment; and generating the negative sample pair based on the first data segment and the third data segment.

According to an example implementation of the present disclosure, generating the third data segment comprises: selecting a data frame from a data sequence other than the second data sequence in the plurality of data sequences; and generating the third data segment by updating an appearance of the second data segment with the data frame.

According to an example implementation of the present disclosure, generating the third data segment comprises: generating a noise data frame based on the data frame; and updating a data frame of the second data segment with the noise data frame.

According to an example implementation of the present disclosure, generating the noise data frame comprises: generating an intermediate data frame by adjusting a dimension of the data frame based on a preset ratio; generating a plurality of copied intermediate data frames by copying the intermediate data frame; and generating the noise data by joining the plurality of copied intermediate data frames.

According to an example implementation of the present disclosure, generating the third data segment comprises: generating the third data segment by adjusting the sampling frequency of a plurality of data frames of the second data segment.

According to an example implementation of the present disclosure, the method 1300 further comprises: generating a negative sample pair of the second training sample set by: adding a negative sample pair from the first training sample set to the second training sample set;

obtaining a fourth data segment from the first data sequence; generating a fifth data segment by adjusting a sampling frequency of a plurality of data frames in the fourth data segment; and generating a negative sample pair of the second training sample set based on the first data segment and the fifth data segment.

According to an example implementation of the present disclosure, the method 1300 further comprises generating a positive sample pair of the first training sample set and the second training sample set based on:
obtaining a sixth data segment from the first data sequence; generating a seventh data segment based on a data frame in data sequences other than the first data sequence in the plurality of data sequences and the sixth data segment; and determining the positive sample pair based on the first data segment and the seventh data segment.

According to an example implementation of the present disclosure, training the contrastive learning model with a first training sample set comprises: in a training cycle of a plurality of training cycles of the first training, training the contrastive learning model with a portion of training samples in the first training sample set corresponding to the training cycle.

According to an example implementation of the present disclosure, the method 1300 further comprises: obtaining a total number of a plurality of training cycles for training the contrastive learning model and a first weight associated with the first training phase; and determining a plurality of training cycles of the first training phase based on the total number and the first weight.

According to an example implementation of the present disclosure, the method 1300 further comprises: determining an association between a first data segment and a second data segment of a sample pair to be processed with the second contrastive learning model.

### Example Apparatus and Equipment

FIG. 14 shows a block diagram 1400 of an apparatus for managing the contrastive learning model according to some implementations of the present disclosure. The apparatus 1400 comprises: a first training module 1410, configured to, in a first training phase, generate the first contrastive learning model by training the contrastive learning model with a first training sample set, a negative sample pair of the first training sample set comprising only data segments from different data sequences; and a second training module 1420, configured to, in a second training phase, generate a second contrastive learning model by training the first contrastive learning model with a second training sample set, a negative sample pair in the second training sample set comprising data segments from the same data sequence.

According to an example implementation of the present disclosure, the apparatus further comprises a first generation module configured to generate a negative sample pair of the first training sample set a negative sample pair of the first training sample set, the first generation module comprising: an obtaining module configured to obtain a first data segment from a first data sequence of a plurality of data sequences for training the contrastive learning model, and obtaining a second data segment from a second data sequence of the plurality of data sequences; and a negative sample pair generation module configured to generate the negative sample pair based on the first data segment and the second data segment.

According to an example implementation of the present disclosure, the negative sample pair generation module further comprises: a data segment generation module configured to generate a third data segment by updating at least one of an appearance and a sampling frequency of a plurality of data frames of the second data segment; and a data segment-based generation module configured to generate the negative sample pair based on the first data segment and the third data segment.

According to an example implementation of the present disclosure, the data segment generation module comprises: a selection module configured to select a data frame from a data sequence other than the second data sequence in the plurality of data sequences; and an update module configured to generate the third data segment by updating an appearance of the second data segment with the data frame.

According to an example implementation of the present disclosure, the update module comprises: a noise generation module configured to generate a noise data frame based on the data frame; and a noise-based update module configured to update a data frame of the second data segment with the noise data frame.

According to an example implementation of the present disclosure, the noise generation module comprises: an adjustment module configured to generate an intermediate data frame by adjusting a dimension of the data frame based on a preset ratio; a replication module configured to generate a plurality of copied intermediate data frames by copying the intermediate data frame; and a joining module configured to generate the noise data by joining the plurality of copied intermediate data frames.

According to an example implementation of the present disclosure, the data segment generation module comprises: a sampling frequency adjustment module configured to generate the third data segment by adjusting the sampling frequency of a plurality of data frames of the second data segment.

According to an example implementation of the present disclosure, the apparatus further comprises: a second negative sample generation module configured to generate a negative sample pair of the second training sample set, the second negative sample generation module comprising: an addition module configured to add a negative sample pair from the first training sample set to the second training sample set; an obtaining module configured to obtain a fourth data segment from the first data sequence; a sampling frequency adjustment module configured to generate a fifth data segment by adjusting a sampling frequency of a plurality of data frames in the fourth data segment; and a data segment-based generation module configured to generate a negative sample pair of the second training sample set based on the first data segment and the fifth data segment.

According to an example implementation of the present disclosure, the device further comprises a positive sample generation module configured to generate a positive sample pair of the first training sample set and the second training sample set; the positive sample generation module comprises: an obtaining module configured to obtain a sixth data segment from the first data sequence; a data segment generation module configured to generate a seventh data segment based on a data frame in data sequences other than the first data sequence in the plurality of data sequences and the sixth data segment; and a data segment-based generation module configured to determine the positive sample pair based on the first data segment and the seventh data segment.

According to an example implementation of the present disclosure, the first training module is further configured to: in a training cycle of a plurality of training cycles of the first training, train the contrastive learning model with a portion of training samples in the first training sample set corresponding to the training cycle.

According to an example implementation of the present disclosure, the apparatus further comprises: a cycle and weight obtaining module configured to obtain a total number of a plurality of training cycles for training the contrastive learning model and a first weight associated with the first training phase; and a cycle determination module configured to determine a plurality of training cycles of the first training phase based on the total number and the first weight.

According to an example implementation of the present disclosure, the device further comprises: an application module configured to determine an association between a first data segment and a second data segment of a sample pair to be processed with the second contrastive learning model.

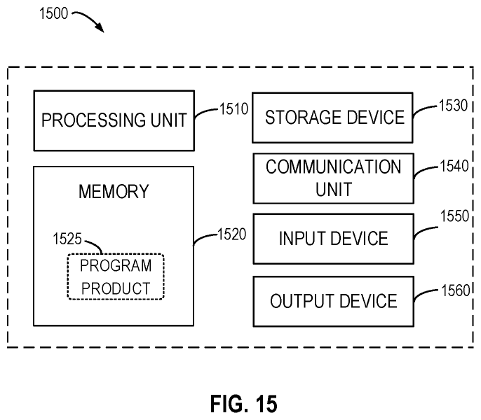

FIG. 15 shows an electronic device 1500 in which one or more implementations of the present disclosure may be implemented. It would be understood that the electronic device 1500 shown in FIG. 15 is only an example and should not constitute any restriction on the function and scope of the implementations described herein.

As shown in FIG. 15, the electronic device 1500 is in the form of a general computing device. The components of the electronic device 1500 may comprise but are not limited to, one or more processors or processing units 1510, a memory 1520, a storage device 1530, one or more communication units 1540, one or more input devices 1550, and one or more output devices 1560. The processing unit 1510 may be an actual or virtual processor and can execute various processes according to the programs stored in the memory 1520. In a multiprocessor system, a plurality of processing units execute computer executable instructions in parallel to improve the parallel processing capability of the electronic device 1500.

The electronic device 1500 typically comprises a variety of computer storage medium. Such medium may be any available medium that is accessible to the electronic device 1500, comprising but not limited to volatile and non-volatile medium, removable, and non-removable medium. The memory 1520 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 1530 may be any removable or non-removable medium and may comprise a machine-readable medium, such as a flash drive, a disk, or any other medium, which can be used to store information and/or data (such as training data for training) and can be accessed within the electronic device 1500.

The electronic device 1500 may further comprise additional removable/non-removable, volatile/non-volatile storage medium. Although not shown in FIG. 15, a disk driver for reading from or writing to a removable, non-volatile disk (such as a “floppy disk”), and an optical disk driver for reading from or writing to a removable, non-volatile optical disk can be provided. In these cases, respective driver may be connected to the bus (not shown) by one or more data medium interfaces. The memory 1520 may comprise a computer program product 1525, which has one or more program modules configured to perform various methods or acts of various implementations of the present disclosure.

The communication unit 1540 communicates with a further computing device through the communication medium. In addition, functions of components in the electronic device 1500 may be implemented by a single computing cluster or a plurality of computing machines, which can communicate through a communication connection. Therefore, the electronic device 1500 may be operated in a networking environment with a logical connection with one or more other servers, a network personal computer (PC), or another network node.

The input device 1550 may be one or more input devices, such as a mouse, a keyboard, a trackball, etc. The output device 1560 may be one or more output devices, such as a display, a speaker, a printer, etc. The electronic device 1500 may also communicate with one or more external devices (not shown) through the communication unit 1540 as required. The external device, such as a storage device, a display device, etc., communicates with one or more devices that enable users to interact with the electronic device 1500, or communicate with any device (for example, a network card, a modem, etc.) that makes the electronic device 1500 communicate with one or more other computing devices. Such communication may be executed via an input/output (I/O) interface (not shown).

According to the example implementation of the present disclosure, a computer-readable storage medium is provided, on which a computer-executable instruction or computer program is stored, wherein the computer-executable instructions or the computer program is executed by the processor to implement the method described above.

According to the example implementation of the present disclosure, a computer program product is also provided. The computer program product is physically stored on a non-transient computer-readable medium and comprises computer-executable instructions, which are executed by the processor to implement the method described above.

Various aspects of the present disclosure are described herein with reference to the flow chart and/or the block diagram of the method, the device, the equipment, and the computer program product implemented according to the present disclosure. It would be understood that respective block of the flowchart and/or the block diagram and the combination of respective blocks in the flowchart and/or the block diagram may be implemented by computer-readable program instructions.

These computer-readable program instructions may be provided to the processing units of general-purpose computers, special computers, or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device, and/or other devices to work in a specific way. Therefore, the computer-readable medium containing the instructions comprises a product, which comprises instructions to implement various aspects of the functions/acts specified in one or more blocks in the flowchart and/or the block diagram.

The computer-readable program instructions may be loaded onto a computer, other programmable data processing apparatus, or other devices, so that a segment of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions, and operations of the system, the method, and the computer program product implemented according to the present disclosure. In this regard, respective block in the flowchart or the block diagram may represent a part of a module, a program segment, or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that respective block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Respective implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application, or improvement of technology in the market of respective implementation, or to enable other ordinary skills in the art to understand the various implementations disclosed herein.

I/We claim:

1. A method for managing a contrastive learning model, comprising:
in a first training phase, generating a first contrastive learning model by training the contrastive learning model with a first training sample set, a negative sample pair of the first training sample set comprising only data segments from different data sequences; and
in a second training phase, generating a second contrastive learning model by training the first contrastive learning model with a second training sample set, a negative sample pair in the second training sample set comprising data segments from the same data sequence.

2. The method of claim 1, further comprising: generating a negative sample pair of the first training sample set by:
obtaining a first data segment from a first data sequence of a plurality of data sequences for training the contrastive learning model, and obtaining a second data segment from a second data sequence of the plurality of data sequences; and
generating the negative sample pair based on the first data segment and the second data segment.

3. The method of claim 2, wherein generating the negative sample pair based on the first data segment and the second data segment further comprises:
generating a third data segment by updating at least one of an appearance and a sampling frequency of a plurality of data frames of the second data segment; and
generating the negative sample pair based on the first data segment and the third data segment.

4. The method of claim 3, wherein generating the third data segment comprises:
selecting a data frame from a data sequence other than the second data sequence in the plurality of data sequences; and
generating the third data segment by updating an appearance of the second data segment with the data frame.

5. The method of claim 4, wherein generating the third data segment comprises:
generating a noise data frame based on the data frame; and
updating a data frame of the second data segment with the noise data frame.

6. The method of claim 5, wherein generating the noise data frame comprises:
generating an intermediate data frame by adjusting a dimension of the data frame based on a preset ratio;
generating a plurality of copied intermediate data frames by copying the intermediate data frame; and
generating the noise data by joining the plurality of copied intermediate data frames.

7. The method of claim 4, wherein generating the third data segment comprises: generating the third data segment by adjusting the sampling frequency of a plurality of data frames of the second data segment.

8. The method of claim 1, further comprising: generating a negative sample pair of the second training sample set by:
adding a negative sample pair from the first training sample set to the second training sample set;
obtaining a fourth data segment from the first data sequence;
generating a fifth data segment by adjusting a sampling frequency of a plurality of data frames in the fourth data segment; and
generating a negative sample pair of the second training sample set based on the first data segment and the fifth data segment.

9. The method of claim 1, further comprising: generating a positive sample pair of the first training sample set and the second training sample set based on:
obtaining a sixth data segment from the first data sequence;
generating a seventh data segment based on a data frame in data sequences other than the first data sequence in the plurality of data sequences and the sixth data segment; and
determining the positive sample pair based on the first data segment and the seventh data segment.

10. The method of claim 1, wherein training the contrastive learning model with a first training sample set comprises: in a training cycle of a plurality of training cycles of the first training, training the contrastive learning model with a portion of training samples in the first training sample set corresponding to the training cycle.

11. The method of claim 10, further comprising:
obtaining a total number of a plurality of training cycles for training the contrastive learning model and a first weight associated with the first training phase; and
determining a plurality of training cycles of the first training phase based on the total number and the first weight.

12. The method of claim 1, further comprising: determining an association between a first data segment and a second data segment of a sample pair to be processed with the second contrastive learning model.

13. An electronic device, comprising:
at least one processing unit; and
at least one memory coupled to the at least one processing unit and storing instructions to be executed by the at least one processing unit, the instructions, when executed by the at least one processing unit, causing the electronic device to perform a method for managing a contrastive learning model, comprising:
in a first training phase, generating a first contrastive learning model by training the contrastive learning model with a first training sample set, a negative sample pair of the first training sample set comprising only data segments from different data sequences; and
in a second training phase, generating a second contrastive learning model by training the first contrastive learning model with a second training sample set, a negative sample pair in the second training sample set comprising data segments from the same data sequence.

14. The device of claim 13, further comprising: generating a negative sample pair of the first training sample set by:
obtaining a first data segment from a first data sequence of a plurality of data sequences for training the contrastive learning model, and obtaining a second data segment from a second data sequence of the plurality of data sequences; and
generating the negative sample pair based on the first data segment and the second data segment.

15. The device of claim 14, wherein generating the negative sample pair based on the first data segment and the second data segment further comprises:
generating a third data segment by updating at least one of an appearance and a sampling frequency of a plurality of data frames of the second data segment; and
generating the negative sample pair based on the first data segment and the third data segment.

16. The device of claim 15, wherein generating the third data segment comprises:
selecting a data frame from a data sequence other than the second data sequence in the plurality of data sequences; and
generating the third data segment by updating an appearance of the second data segment with the data frame.

17. The device of claim 16, wherein generating the third data segment comprises:
generating a noise data frame based on the data frame; and
updating a data frame of the second data segment with the noise data frame.

18. The device of claim 17, wherein generating the noise data frame comprises:
generating an intermediate data frame by adjusting a dimension of the data frame based on a preset ratio;
generating a plurality of copied intermediate data frames by copying the intermediate data frame; and
generating the noise data by joining the plurality of copied intermediate data frames.

19. The device of claim 16, wherein generating the third data segment comprises:
generating the third data segment by adjusting the sampling frequency of a plurality of data frames of the second data segment.

20. A non-transitory computer-readable storage medium having a computer program stored thereon, the computer program, when executed by a processor, implementing a method for managing a contrastive learning model, comprising:
in a first training phase, generating a first contrastive learning model by training the contrastive learning model with a first training sample set, a negative sample pair of the first training sample set comprising only data segments from different data sequences; and
in a second training phase, generating a second contrastive learning model by training the first contrastive learning model with a second training sample set, a negative sample pair in the second training sample set comprising data segments from the same data sequence.
